(19) United States
(12) Patent Application Publication
(10) Pub. No.: US 2021/0009870 A1
(43) Pub. Date: Jan. 14, 2021

(54) SURFACE PROTECTION FILM

(71) Applicant: TREDEGAR SURFACE PROTECTION, LLC, N. Chesterfield, VA (US)

(72) Inventors: Surya SSUBRAMANIAM, Richmond, VA (US); Ricky SANTOSO, Glen Allen, VA (US)

(21) Appl. No.: 16/904,880

(22) Filed: Jun. 18, 2020

Related U.S. Application Data
(60) Provisional application No. 62/871,776, filed on Jul. 9, 2019.

(51) Int. Cl. C09J 153/02; C09J 7/20; C09J 7/24; C09J 7/35; C08F 236/06; C08F 236/08; C08F 8/04; C08L 25/08

(52) U.S. Cl. CPC C09J 153/025; C08L 2207/066; C09J 7/243; C09J 7/35; C08F 236/06; C08F 236/08; C08F 8/04; C08L 25/08; C09J 2203/31; C09J 2409/00; C09J 2423/041; C09J 2423/045; C09J 2423/105; C09J 2425/00; C09J 2453/00; C09J 2469/006; C08L 2205/02; C08L 2205/035; C08L 2207/062; C09J 7/201

(57) ABSTRACT

A surface protection film includes an adhesion layer that includes a blend of a first hydrogenated styrene block copolymer, a second hydrogenated styrene block copolymer different from the first hydrogenated styrene block copolymer, and polyethylene. An Adhesion Build Value of the surface protection film is less than 2.5 after the adhesion layer has been attached to a textured polycarbonate substrate and heated to 90° C. for 10 minutes.

### CROSS-REFERENCE TO RELATED PATENT APPLICATION(S)

This application claims the benefit of priority from U.S. Provisional Patent Application No. 62/871,776, filed Jul. 9, 2019, the entire content of which is incorporated herein by reference.

### FIELD

The present invention generally relates to a surface protection film for protecting substrates.

### BACKGROUND

Surface protection films, also known as masking films, are typically used to provide a physical barrier to prevent damage, contamination, scratching, scuffing, and/or other marring of a substrate to which they are adhered. Surface protection films may be applied to delicate, sensitive substrates that are used as components of electronic displays, and protect the substrates through one or more subsequent processing steps during manufacturing, as well as during shipping, and/or storage prior to use of the substrate.

Commonly used surface protection films achieve adhesion to substrates by, for example, van der Walls forces, which require the surface protection film and substrate to each have at least one very flat and uniform surface so the surface protection film can intimately contact the substrate.

As referred to herein, “adhesion” means adherence to a surface of the substrate to be protected through intimate contact via the natural blocking adhesion that exists between a very smooth surface and another smooth surface via polar bonding, ionic bonding and, in some instances, hydrogen bonding, and/or van der Waals secondary bonding. “Adhesive-less” adhesion is intended herein to encompass a releasable adhesion where the adhesion is reversible such that neither the film nor the substrate to which it is applied is modified or damaged. “Adhesion,” as used herein, does not include the heat bonding or cross-linking functionality of adhesives as the adhesion force between the substrate surface and a film with pressure sensitive adhesives, or the heat bonding or cross-linking functionality of adhesives that is elevated to a point where the peel strength needed to remove such a film will exceed the tensile strength of such a film itself thus causing such a film to tear or break before it will peel away from the substrate.

The amount of adhesion can be increased or decreased by softening or hardening the composition of the surface protection film surface. Too much adhesion makes it difficult to remove the surface protection film from the substrate at the end of the process. Too little adhesion may result in the surface protection film separating prematurely from the substrate, so the substrate is no longer protected. If the surface of the substrate to be protected has a textured surface, increased adhesion may be needed to prevent the surface protection film from separating prematurely from the substrate.

A suitable surface protection film for protecting surfaces, including textured surfaces, is disclosed in commonly owned U.S. Pat. No. 10,150,896. The adhesion layers of the surface protection films disclosed therein include blends of hydrogenated styrene block copolymer, high density polyethylene (HDPE), and low density polyethylene (LDPE). Table 3 of U.S. Pat. No. 10,150,896 lists adhesion test results for a series of films after the films had been laminated to a polycarbonate substrate and subjected to different temperatures. The data listed in Table 3 of U.S. Pat. No. 10,150,896 indicates that the adhesion of the surface protection film to the polycarbonate substrate increases after the laminate was subjected to elevated temperatures, thereby making removal of the surface protection film more difficult, which may be undesirable for some applications. The increase in adhesion may be represented by an “Adhesion Build Value,” which is a ratio of the peel testing result at the elevated temperature to the peel testing result at room temperature.

It is desirable to have a surface protection film that provides the desired surface protection of a substrate, without damaging the surface of the substrate during use or during removal of the surface protection film when the surface protection film is no longer needed, even if the surface protection film and substrate are subjected to elevated temperatures. It is also desirable for the surface protection film to have a low Adhesion Build Value, thereby indicating that the adhesion properties of the surface protection film do not substantially increase at elevated temperatures.

### SUMMARY

According to an aspect of the invention, there is provided a surface protection film includes an adhesion layer that includes a blend of a first hydrogenated styrene block copolymer, a second hydrogenated styrene block copolymer different from the first hydrogenated styrene block copolymer, and polyethylene. An Adhesion Build Value of the surface protection film is less than 2.5 after the adhesion layer has been attached to a textured polycarbonate substrate and heated to 90° C. for 10 minutes.

In an embodiment, the Adhesion Build Value of the surface protection film is less than 2.0 after the adhesion layer has been attached to a textured polycarbonate substrate and heated to 90° C. for 10 minutes.

In an embodiment, the Adhesion Build Value of the surface protection film is less than 1.5 after the adhesion layer has been attached to a textured polycarbonate substrate and heated to 90° C. for 10 minutes.

In an embodiment, the first hydrogenated styrene block copolymer includes about 34 wt % styrene and has a Melt Flow Rate at 230° C. and 2.16 kg of about 48 grams/10 minutes.

In an embodiment, the second hydrogenated styrene block copolymer includes about 65 wt % styrene and has a Melt Flow Rate at 230° C. and 2.16 kg of about 0.4 grams/10 minutes.

In an embodiment, the adhesion layer blend includes a total of 25 wt %-50 wt % hydrogenated styrene block copolymer, 25 wt %-40 wt % low density polyethylene, and 25 wt %-35 wt % high density polyethylene.

In an embodiment, the adhesion layer blend includes 15 wt %-35 wt % of the first hydrogenated styrene block copolymer and 5 wt %-25 wt % of the second hydrogenated styrene block copolymer.

In an embodiment, the surface protection film includes a release layer. In an embodiment, the release layer consists essentially of low density polyethylene.

In an embodiment, the surface protection film includes a core layer in between the adhesion layer and the release layer.

In an embodiment, the core layer includes a blend of high density polyethylene and low density polyethylene. In an embodiment, the core layer blend includes 30 wt %-50 wt % low density polyethylene and 50 wt %-70 wt % high density polyethylene.

These and other aspects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The components of the following figures are illustrated to emphasize the general principles of the present disclosure.

FIG. 1 schematically illustrates a surface protection film according to embodiments of the invention adhered to a substrate;

FIG. 2 illustrates Peel Force Values for a series of surface protection films that were laminated to a smooth surface of a polycarbonate substrate and subjected to different temperatures;

FIG. 3 illustrates Adhesion Build Values calculated from the Peels Force Values of FIG. 2;

FIG. 4 illustrates Peel Force Values for a series of surface protection films after the surface protection films were laminated to a textured surface of a polycarbonate substrate and subjected to different temperatures; and

FIG. 5 illustrates Adhesion Build Values calculated from the Peels Force Values of FIG. 4.

### DETAILED DESCRIPTION

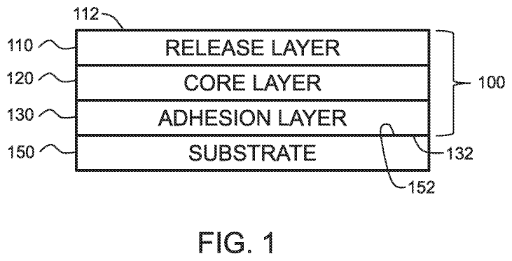

FIG. 1 schematically illustrates a surface protection film 100 according to embodiments of the invention. As illustrated, the surface protection film 100 is a multilayer film that includes a release layer 110 having an outer release surface 112, a core layer 120, and an adhesion layer 130 on an opposite side of the core layer 120 than the release layer 110. The adhesion layer 130 includes an outer adhesive surface 132. The outer adhesive surface 132 of the adhesion layer 130 is configured to contact a surface 152 of a substrate 150 to be protected by the surface protection film 100, such as an optical film for a display of an electronic device.

In an embodiment, the surface protection film 100 may have a thickness of between about 30 μm and about 70 μm. In an embodiment, the surface protection film 100 may have a thickness between about 40 μm and about 60 μm. In an embodiment, the surface protection film 100 may have a thickness of about 50 μm. In an embodiment, the thickness ratio of the three layers 110, 120, 130 may be about 15:65:20, i.e., 15% release layer 110, 65% core layer 120, and 20% adhesion layer 130.

### Release Layer

The release layer 110 may include one or more polyolefins, such as low density polyethylene (LDPE), linear low density polyethylene (LLDPE), high density polyethylene (HDPE), medium density polyethylene (MDPE), polypropylene (PP), random copolymer polypropylene, polypropylene impact copolymers, or metallocene linear low density polyethylene, plastomers, poly (ethylene-co-vinyl acetate), poly (ethylene-co-acrylic acid), poly (ethylene-comethyl acrylate), cyclic olefin polymers, polyamides, poly (ethylene-co-n-butyl acrylate), and mixtures thereof. In an embodiment, the release layer 110 may include a suitable polyolefin mixture of low density polyethylene (LDPE) and high density polyethylene (HDPE) in a ratio of 60:40 to 40:60 by weight. In an embodiment, the release layer 110 may include LDPE, but not include HDPE. In an embodiment, one or more additives, such as an antioxidant, may be included in the release layer 110.

The thickness of the release layer 110 may be between about 1 μm and about 20 μm, such as between about 5 μm and about 12 μm, such as about 1 μm, about 2 μm, about 3 μm, about 4 μm, about 5 μm, about 6 μm, about 7 μm, about 8 μm, about 9 μm, about 10 μm, about 11 μm, or about 12 μm.

As discussed herein, smoothness and roughness will be defined as the arithmetic average height (Ra) of the micropeaks and microvalleys of a surface to the center line of such surface as measured by a profilometer. Smoothness and roughness defined in this manner is typically expressed with units of microinches (10⁻⁶ inches). All testing of surface textures (relative smoothness and roughness) were conducted in accordance with ANSI/ASME Test Method B46.1-1985. The outer surface 112 of the release layer 110 may have an average surface roughness Ra of between about 3 microinches and about 600 microinches. In an embodiment, the outer surface 112 of the release layer 110 may have an average surface roughness Ra of between about 30 microinches and about 300 microinches.

### Core Layer

The core layer 120 may include one or more polyolefins, such as low density polyethylene (LDPE), linear low density polyethylene (LLDPE), high density polyethylene (HDPE), medium density polyethylene, polypropylene (PP), random copolymer polypropylene, polypropylene impact copolymers, metallocene linear low density polyethylene, plastomers, poly(ethylene-co-vinyl acetate), poly(ethylene-co-acrylic acid), poly(ethylene-co-methyl acrylate), cyclic olefin polymers, polyamides, poly(ethyleneco-n-butyl acrylate), and mixtures thereof. One suitable polyolefin mixture includes low density polyethylene (LDPE) and high density polyethylene (HDPE) in a ratio in a range of 60:40 to 40:60 by weight. The core layer 120 may include one or more additives, such as an antioxidant.

The thickness of the core layer 120 of the surface protection film 100 in accordance with embodiments of the invention may be between about 10 μm and about 50 μm, such as between about 20 μm and about 40 μm, such as about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm or about 40 μm.

### Adhesion Layer

The adhesion layer 130 according to embodiments of the surface protection film 100 includes a blend of one or more polyolefins, such as a low density polyethylene (LDPE) and/or a high density polyethylene (HDPE), and one or more hydrogenated styrene block copolymers. Suitable hydrogenated styrene block copolymers have a polystyrene block-polydiene block polymer structure prior to hydrogenation. The hydrogenated block copolymer, before hydrogenation, can be linear or radial. Suitable polydienes for the hydrogenated styrene block copolymer include polybutadiene (1,3-butadiene), polyisoprene and mixtures thereof. Hydrogenation of the polystyrene block-polydiene block structure may result in a styrene-ethylene-butylene-styrene polymeric structure, otherwise referred to as “SEBS”, or a styrene-ethylene-propylene-styrene, otherwise referred to as “SEPS”, for example. In embodiments of the invention, the styrene content of the hydrogenated styrene block copolymer may be between 10 wt % and 70 wt %.

The Melt Flow Rates (“MFR”) of thermoplastics, such as styrene block copolymers, are inversely correlated to viscosities of the thermoplastics. A high MFR means that the thermoplastic has a low viscosity and vice-versa. As used herein, unless otherwise stated, “MFR” shall mean the Melt Flow Rate as determined according to ASTM D-1238, at 230° C. under a 2.16 kg mass and measured in grams per 10 minutes. Suitable hydrogenated styrene block copolymers for the adhesion layer 130 may be between about 0.1 g/10 min. and about 100 g/10 min.

In various embodiments of the invention, the adhesion layer 130 may comprise 10% to 90%, by weight, hydrogenated styrene block copolymer. In particular embodiments, the adhesion layer 130 may comprise 20% to 50%, by weight, hydrogenated styrene block copolymer. In such embodiments, the adhesion layer 130 may also comprise 50% to 80%, by weight, of a blend of LDPE and HDPE.

The thickness of the adhesion layer 130 of the surface protection film 100 in accordance with embodiments of the present invention may be between about 1 μm and about 20 μm, such as between about 3 μm and about 15 μm, such as about 3 μm, about 4 μm, about 5 μm, about 6 μm, about 7 μm, about 8 μm, about 9 μm, about 10 μm, about 11 μm, about 12 μm, about 13 μm, about 14 μm, or about 15 μm.

### Substrates

While the surface protection film 100 of the present invention may be applied to any substrate 150, typical substrates include, by way of illustration only, polycarbonate, acrylic, polyvinylchloride, polyethylene terephthalate (PET), glycol modified polyethylene terephthalate (PETG), polyimide, glass, ceramic and metal. Such substrates typically have an average surface roughness Ra in the range of between about 0 microinches and about 150 microinches. Substrates 150 may have a smooth surface 152 (i.e. a surface having an average surface roughness Ra in the range of about 0 microinches to about 5 microinches, or a textured surface 152 having an average surface roughness Ra in the range of about 5 microinches to about 150 microinches.

### Application of Surface Protection Film to Substrates

Any of a variety of conventional methods can be utilized for applying the multilayer surface protection film 100 to the substrate 150 and for pressing the applied surface protection film 100 against the surface 152 of the substrate 150. Generally speaking, the surface protection film 100 may be taken off from a roll and directly applied to the substrate 150 by means of a nip roll or similar system through which the surface protection film 100 and the substrate 150 are passed. As the surface protection film 100 is pulled off the roll, the spiral orientation of the surface protection film 100 on the roll has the outer surface 132 of the adhesion layer 130 disengaging from the outer surface 112 of the release layer 110, without damaging either layer or the surface protection film as a whole.

### Examples

A series of three-layer surface protection films 100 were extruded on a co-extrusion cast film line using the same conditions. The target total thickness of each film 100 was about 50 μm (microns), with 15% of the total thickness attributable to the release layer 110, about 65% of the total thickness attributable to the core layer 120, and about 20% of the total thickness attributable to the adhesion layer 130. The release layer 110 for each film 100 consisted essentially of LDPE. The core layer 120 for each film 100 was a blend of about 60 wt % HDPE and about 40 wt % LDPE. For the adhesion layer 130, different hydrogenated styrene block copolymers were blended with LDPE and HDPE. A summary of the different hydrogenated styrene block copolymers that were used in the adhesion layer 130 are listed in Table I below.

TABLE I
SUMMARY OF STYRENE BLOCK COPOLYMERS
FOR ADHESION LAYER BLEND

| Hydrogenated | | Styrene | |
|---|---|---|---|
| Styrene Block | | Content | MFR |
| Copolymer Grade | Type | (wt %) | (g/10 min.) |
| Kraton ™ MD6951 | SEBS | 34 | 48 |
| Kraton ™ MD1653 | SEBS | 30 | 25 |
| Septon ™ 2063 | SEPS | 13 | 7 |
| Septon ™ 2104 | SEPS | 65 | 0.4 |

Kraton™ MD 6951 and Kraton™ MD1653 are manufactured by Kraton Performance Polymers, Inc., and Septon™ 2063 and Septon™ 2104 are manufactured by Kuraray Co., Ltd. Table II lists the various blends that were used as the adhesion layer 130 for the surface protection film 100 to determine the effect the different hydrogenated styrene block copolymers have on the adhesion properties of the surface protection film 100 when laminated to a polycarbonate substrate 150 having a smooth surface 152. It is noted that the adhesion layer of Comparative Example A is similar to the adhesion layer of Example 3 of Table 3 in U.S. Pat. No. 10,150,896, discussed above.

TABLE II
SUMMARY OF BLENDS FOR ADHESION LAYER

| | | Styrene Block | | |
|---|---|---|---|---|
| | Styrene Block | Copolymer | HDPE | LDPE |
| Sample | Copolymer Type | (wt %) | (wt %) | (wt %) |
| Comparative | Kraton ™ MD6951 | 25 | 35 | 40 |
| Example A | | | | |
| Example 1 | Kraton ™ MD1653 | 25 | 35 | 40 |
| Example 2 | Septon ™ 2063 | 25 | 35 | 40 |
| Example 3 | Septon ™ 2104 | 25 | 35 | 40 |

Each of the films 100 were aged under ambient conditions (e.g., about 23° C.) for two weeks and then laminated onto a polycarbonate substrate 150 having a smooth surface 152 having an average surface roughness Ra of about 0.7 microinches, with the outer surface 132 of the adhesion layer 130 contacting the smooth surface 152 of the polycarbonate substrate 150. Laminate specimens were cut to a width of 3 inches and allowed to sit at room temperature (e.g., about 23° C.) for one hour, or in an oven at 90° C. for 10 minutes. A TA.XTPlus Texture Analyzer manufactured by Texture Technologies Corp. was used to measure 180° peel force, in grams/3 inches, at a rate of 5 mm/second (“Peel Force Value”). Table III lists the results of the peel force testing, and includes an “Adhesion Build Value”, which is the ratio of the Peel Force Value of the sample that was subjected to the elevated temperature of 90° C. after lamination to the Peel Force Value of the sample that was not subjected to an elevated temperature after lamination (i.e., kept at about 23° C.). An Adhesion Build Value of 1.0 indicates that the adhesion of the film sample was not affected by the elevated temperature, which is desirable.

TABLE III
SUMMARY OF PEEL FORCE VALUES - SMOOTH PC

| | PEEL FORCE | PEEL FORCE | ADHESION |
|---|---|---|---|
| Film | VALUE @ 23° C. | VALUE @90° C. | BUILD VALUE |
| Sample | (grams/3 in.) | (grams/3 in.) | @90° C. |
| Comparative | 74.6 | 120.5 | 1.62 |
| Example A | | | |
| Example 1 | 26.1 | 27.2 | 1.04 |
| Example 2 | 2.3 | 3.5 | 1.52 |
| Example 3 | 4.3 | 7.3 | 1.70 |

Although the Adhesion Build Value of Example 1 was about 1.0, the Peel Force Value of Example 1 was about one-third the Peel Force Value of Comparative Example A, which may not be high enough for some applications.

Additional samples were made to determine the effect of replacing a small amount (about 5 wt %) of the hydrogenated styrene block copolymer of the blends of Comparative Example A, Example 1 and Example 2 with the hydrogenated styrene block copolymer of Example 3 (Septon™ 2104). A summary of such samples is listed in Table IV.

TABLE IV
SUMMARY OF ADHESION LAYER BLENDS FOR SAMPLES WITH
TWO HYDROGENATED STYRENE BLOCK COPOLYMERS

| | Hydrogenated | Hydrogenated | | |
|---|---|---|---|---|
| | Styrene Block | Styrene Block | | |
| Film | Copolymer #1 | Copolymer #2 | HDPE | LDPE |
| Sample | (wt %) | (wt %) | (wt %) | (wt %) |
| Example 4 | Kraton ™ MD6951 (20) | Septon ™ 2104 (5) | 35 | 40 |
| Example 5 | Kraton ™ MD1653 (20) | Septon ™ 2104 (5) | 35 | 40 |
| Example 6 | Septon ™ 2063 (20) | Septon ™ 2104 (5) | 35 | 40 |

Each of the films 100 were aged under ambient conditions (e.g., about 23° C.) for two weeks and then laminated onto a polycarbonate substrate 150 having a smooth surface 152 having an average surface roughness Ra of about 0.7 microinches, with the outer surface 132 of the adhesion layer 130 contacting the smooth surface 152 of the polycarbonate substrate 150. Laminate specimens were cut to a width of 3 inches and allowed to sit at room temperature (e.g., about 23° C.) for one hour, or in an oven at 90° C. for 10 minutes. The TA.XTPlus Texture Analyzer manufactured by Texture Technologies Corp. was used to measure 180° peel force, in grams/3 inches, at a rate of 5 mm/second (“Peel Force Value”). Table V lists the results of the peel force testing, and includes the Adhesion Build Value, described above.

TABLE V
SUMMARY OF PEEL FORCE VALUES - SMOOTH PC

| | PEEL FORCE | PEEL FORCE | ADHESION |
|---|---|---|---|
| Film | VALUE @ 23° C. | VALUE @90° C. | BUILD VALUE |
| Sample | (grams/3 in.) | (grams/3 in.) | @90° C. |
| Comparative | 74.6 | 120.5 | 1.62 |
| Example A | | | |
| Example 4 | 55.7 | 60.9 | 1.09 |
| Example 5 | 9.6 | 15.5 | 1.61 |
| Example 6 | 5.7 | 3.2 | 0.56 |

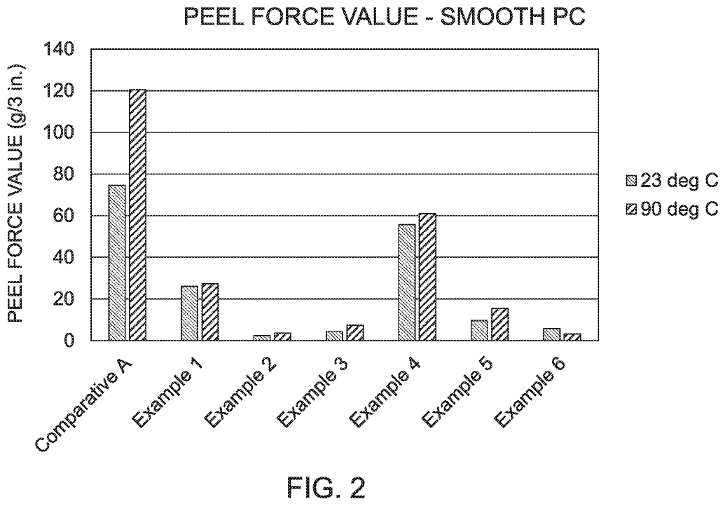

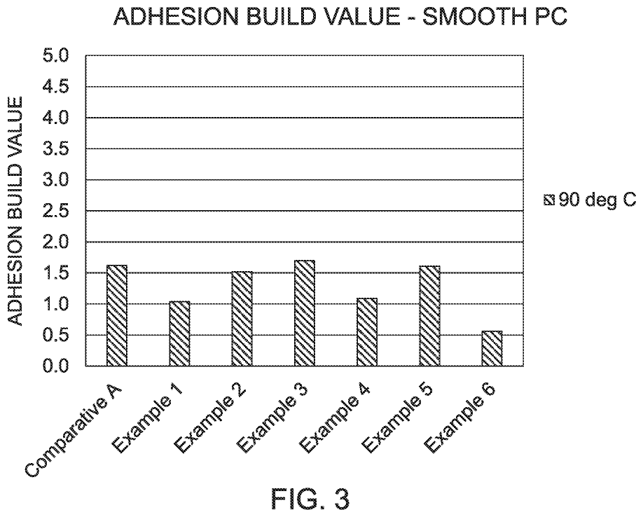

The Peel Force Value of the laminate with the film of Example 4 that was kept at room temperature was only about 25% lower than the Peel Force Value of the laminate with the film of Comparative Example A that was kept at room temperature, but advantageously had an Adhesion Build Value of about 1.1, as compared to the Adhesion Build Value of about 1.6 for Comparative Example A. The Peel Force Values for Comparative Example A and Examples 1-6 are also illustrated in FIG. 2 and the Adhesion Build Values of such samples are illustrated in FIG. 3.

Because the blends with Kraton™ MD6951 (Comparative Example A and Example 4) were tested to have higher Peel Force Values than the blends without Kraton™ MD6951 (Examples 1-3, 5 and 6), and the blend with both Kraton™ MD6951 and Septon™ 2104 had an Adhesion Build Value closer to 1.0 than the blend with only Kraton™ MD6951 for the hydrogenated styrene block copolymer, additional samples were made to investigate different levels of both Kraton™ MD6951 and Septon™ 2104 in the adhesion layer 130. A summary of the blends for the adhesion layers 130 of the additional samples that were made are listed in Table VI.

TABLE VI
SUMMARY OF ADHESION LAYER BLENDS FOR SAMPLES

| | Kraton ™ MD6951 | Septon ™ 2104 | HDPE | LDPE |
|---|---|---|---|---|
| Sample | (wt %) | (wt %) | (wt %) | (wt %) |
| Comparative | 25 | 0 | 35 | 40 |
| Example A | | | | |
| Example 4 | 20 | 5 | 35 | 40 |
| Example 7 | 15 | 10 | 35 | 40 |
| Example 8 | 25 | 25 | 25 | 25 |
| Example 9 | 30 | 20 | 25 | 25 |
| Example 10 | 35 | 15 | 25 | 25 |

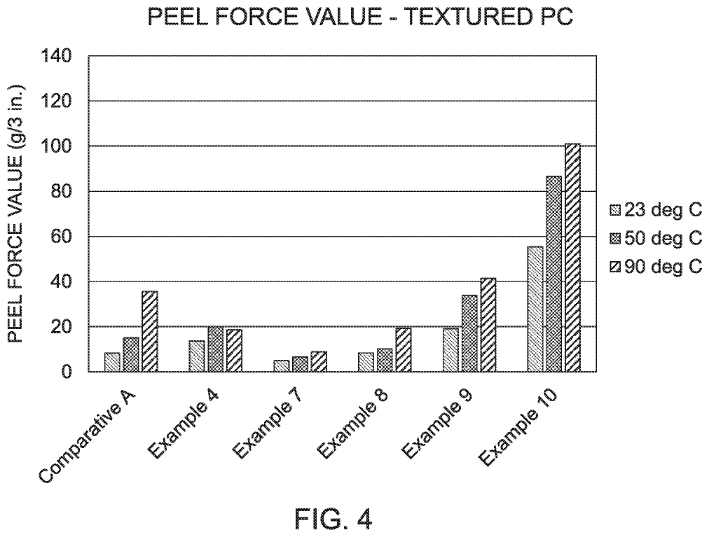

Each of the films were aged under ambient conditions (e.g., about 23° C.) for two weeks and then laminated onto a polycarbonate substrate 150 having a textured surface 152 having an average surface roughness Ra of about 7 microinches, with the outer surface 132 of the adhesion layer 130 contacting the textured surface 152 of the polycarbonate substrate 150. Laminate specimens were cut to a width of 3 inches and allowed to sit at room temperature (e.g., about 23° C.) for one hour, or in an oven at 50° C. for 10 minutes, or in an oven at 90° C. for 10 minutes. The TA.XTPlus Texture Analyzer manufactured by Texture Technologies Corp. was used to measure 180° peel force, in grams/3 inches, at a rate of 5 mm/second (“Peel Force Value”). Table VII lists the results of the peel force testing, and FIG. 4 illustrates the Peel Force Values for each sample.

TABLE VII
SUMMARY OF PEEL FORCE VALUES - TEXTURED PC

| | PEEL FORCE | PEEL FORCE | PEEL FORCE |
|---|---|---|---|
| | VALUE @ 23° C. | VALUE @50° C. | VALUE @90° C. |
| Sample | (grams/3 in.) | (grams/3 in.) | (grams/3 in.) |
| Comparative | 8.3 | 15.1 | 35.6 |
| Example A | | | |
| Example 4 | 13.7 | 20.1 | 18.7 |
| Example 7 | 5.0 | 6.6 | 8.9 |
| Example 8 | 8.4 | 10.2 | 19.3 |
| Example 9 | 19.4 | 33.9 | 41.4 |
| Example 10 | 55.4 | 86.5 | 100.9 |

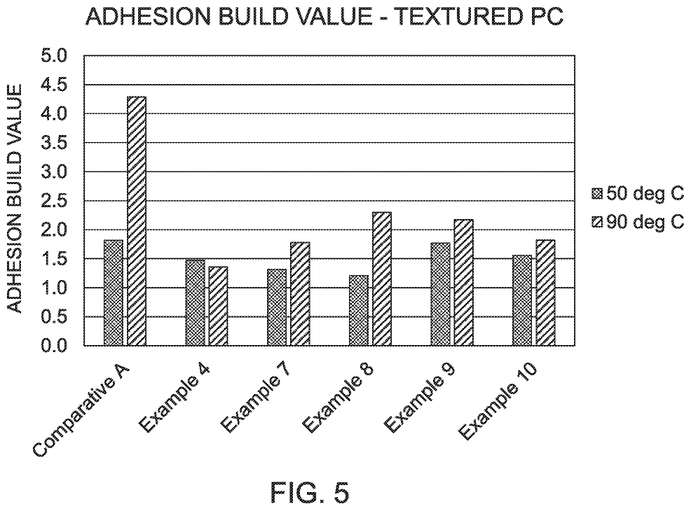

The peel force values listed in Table VII and illustrated in FIG. 4 indicate that for each sample, the peel force generally increased as the temperature increased. Table VIII is a summary of the Adhesion Build Values for the samples at 50° C. and 90° C., and FIG. 5 illustrates the Adhesion Build Values for each of the samples.

TABLE VIII
SUMMARY OF ADHESION BUILD VALUES - TEXTURED PC

| | ADHESION | ADHESION |
|---|---|---|
| | BUILD VALUE | BUILD VALUE |
| Sample | @50° C. | @90° C. |
| Comparative Example A | 1.82 | 4.29 |
| Example 4 | 1.47 | 1.36 |
| Example 7 | 1.32 | 1.78 |
| Example 8 | 1.21 | 2.30 |
| Example 9 | 1.77 | 2.17 |
| Example 10 | 1.56 | 1.82 |

Comparative Example A had an Adhesion Build Value at 90° C. of greater than 4, while Examples 4-8 each had an Adhesion Build Value at 90° C. of less than 2.5, which is desirable. An Adhesion Build Value of less than 2.0 is more desirable, and an Adhesion Build Value of less than 1.5 is most desirable.

It is postulated that the hydrogenated styrene block copolymer having a relatively high MFR (i.e., Kraton™ MD6951) provides relatively high adhesion, while the hydrogenated styrene block copolymer having a very low MFR (i.e., Septon™ 2104) provides temperature stability for the adhesion.

As should be apparent from the foregoing, the present invention combines several aspects that exhibit unexpectedly superior adhesion when compared with prior art protection films. In particular, when a protection film is provided with an adhesion layer comprising a blend of a first hydrogenated styrene block copolymer, a second hydrogenated styrene block copolymer different from the first hydrogenated styrene block copolymer, and polyethylene, it becomes possible to establish an Adhesion Build Value of the surface protection film that is less than 2.5 after the adhesion layer has been attached to a textured polycarbonate substrate and heated to 90° C. for 10 minutes. In one contemplated embodiment, the polyethylene component may encompass a combination of LDPE and HDPE to achieve this unexpected result.

The embodiments described herein represent a number of possible implementations and examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

What is claimed is:

1. A surface protection film comprising:
an adhesion layer comprising a blend of a first hydrogenated styrene block copolymer, a second hydrogenated styrene block copolymer different from the first hydrogenated styrene block copolymer, and polyethylene,
wherein an Adhesion Build Value of the surface protection film is less than 2.5 after the adhesion layer has been attached to a textured polycarbonate substrate and heated to 90° C. for 10 minutes.

2. The surface protection film according to claim 1, wherein the Adhesion Build Value of the surface protection film is less than 2.0 after the adhesion layer has been attached to a textured polycarbonate substrate and heated to 90° C. for 10 minutes.

3. The surface protection film according to claim 1, wherein the Adhesion Build Value of the surface protection film is less than 1.5 after the adhesion layer has been attached to a textured polycarbonate substrate and heated to 90° C. for 10 minutes.

4. The surface protection film according to claim 1, wherein the first hydrogenated styrene block copolymer comprises about 34 wt % styrene and has a Melt Flow Rate at 230° C. and 2.16 kg of about 48 grams/10 minutes.

5. The surface protection film according to claim 1, wherein the second hydrogenated styrene block copolymer comprises about 65 wt % styrene and has a Melt Flow Rate at 230° C. and 2.16 kg of about 0.4 grams/10 minutes.

6. The surface protection film according to claim 1, wherein the adhesion layer blend comprises a total of 25 wt %-50 wt % hydrogenated styrene block copolymer, 25 wt %-40 wt % low density polyethylene, and 25 wt %-35 wt % high density polyethylene.

7. The surface protection film according to claim 1, wherein the adhesion layer blend comprises 15 wt %-35 wt % of the first hydrogenated styrene block copolymer and 5 wt %-25 wt % of the second hydrogenated styrene block copolymer.

8. The surface protection film according to claim 1, further comprising a release layer.

9. The surface protection film according to claim 8, wherein the release layer consists essentially of low density polyethylene.

10. The surface protection film according to claim 8, further comprising a core layer in between the adhesion layer and the release layer.

11. The surface protection film according to claim 10, wherein the core layer comprises a blend of high density polyethylene and low density polyethylene.

12. The surface protection film according to claim 11, wherein the core layer blend comprises 30 wt %-50 wt % low density polyethylene and 50 wt %-70 wt % high density polyethylene.
